(19) United States
(12) Patent Application Publication
(10) Pub. No.: US 2026/0351686 A1
(43) Pub. Date: Nov. 5, 2026

(54) COMPOSITE ELECTRODE ROLL FOR ELECTROCHEMICAL CELLS

(71) Applicant: Zeta Energy Corp., Houston, TX (US)

(72) Inventors: Abdul-Rahman Olabode Raji, Houston, TX (US); Tuo Wang, Houston, TX (US); Rodrigo Villegas Salvatierra, Houston, TX (US); Amarendar Reddy Javidi, Katy, TX (US); Venkata Pavan Raja Manuri, Richmond, TX (US); Michael Thomas Joachim Liedtke, Encinitas, CA (US); Joseph J. Laux, Ermatingen (CH); Thomas Pilette, Oxford, MI (US); Charles L. Maslin, Cliffside Park, NJ (US)

(21) Appl. No.: 19/166,699

(22) PCT Filed: Feb. 7, 2024
(86) PCT No.: PCT/US2024/014835

§ 371 Date: Sep. 18, 2025

Related U.S. Application Data
(60) Provisional application No. 63/491,724, filed on Mar. 22, 2023.

(51) Int. Cl. H01M 10/0587; H01M 4/02; H01M 4/36; H01M 4/38; H01M 4/62; H01M 4/66

(52) U.S. Cl. CPC H01M 10/0587; H01M 4/366; H01M 4/382; H01M 4/625; H01M 4/661; H01M 4/663; H01M 2004/027

(57) ABSTRACT

Describes are systems and methods for producing a laminate roll of electrode material for electrochemical cells. The laminate roll includes a conductive sheet—a current collector—with a carpet of carbon nanotubes as anode material on either side. Each carpet of nanotubes is attached with an adhesive to an ion-source layer, such as a porous polymer separator or lithium foil, to produce a laminate, which is then spooled to form the laminate roll. The laminate roll can later be assembled with cathode materials to produce an electrochemical cell.

### BACKGROUND

An electric battery includes one or more electrochemical cells. Each cell includes a positive electrode (cathode) and a negative electrode (anode) physically separated by an ion conductor (electrolyte). When a cell powers an external circuit, the anode supplies negative charge carriers (electrons) to the cathode via the external circuit and positive charge carriers (cations) to the cathode via the internal electrolyte. The cell is fully discharged when the anode lacks sufficient charge carriers to provide power. During charging, an external power source drives electrons from the cathode to the anode outside the cell and cations from the cathode to the anode via the electrolyte inside the cell.

The anode and cathode must remain physically separate within the cell or the electrons will flow internally, a destructive condition known as an “internal short circuit.” When the electrolyte separating the anode from the cathode is a liquid or a gel, as is common, a thin layer of material descriptively called a “separator” is disposed with the electrolyte between the anode and cathode to prevent them from short circuiting. Separators are permeable to ions, allowing them to move freely in the electrolyte between the electrodes.

Lithium-ion (Li-ion) batteries store charge in the anode as Li cations (aka Li ions). Li-ion batteries are rechargeable and ubiquitous in mobile communications devices and electric vehicles due to their high energy density, a lack of memory effect, and low self-discharge rate. Lithium-metal batteries store charge in the anode as lithium metal, which is superior to Li ions due to a higher theoretical specific capacity, lower electrochemical potential, and lower density. Unfortunately, rechargeable lithium-metal batteries have yet to be commercialized at scale.

### BRIEF DESCRIPTION OF THE DRAWINGS

The present invention is illustrated by way of example, and not by way of limitation, in the figures of the accompanying drawings and in which like references refer to similar elements and in which:

FIG. 1 depicts a system 100 for producing a laminate roll 105 of electrode material for electrochemical cells.

FIG. 2 depicts electrode laminates 200, 250, and 260.

### DETAILED DESCRIPTION

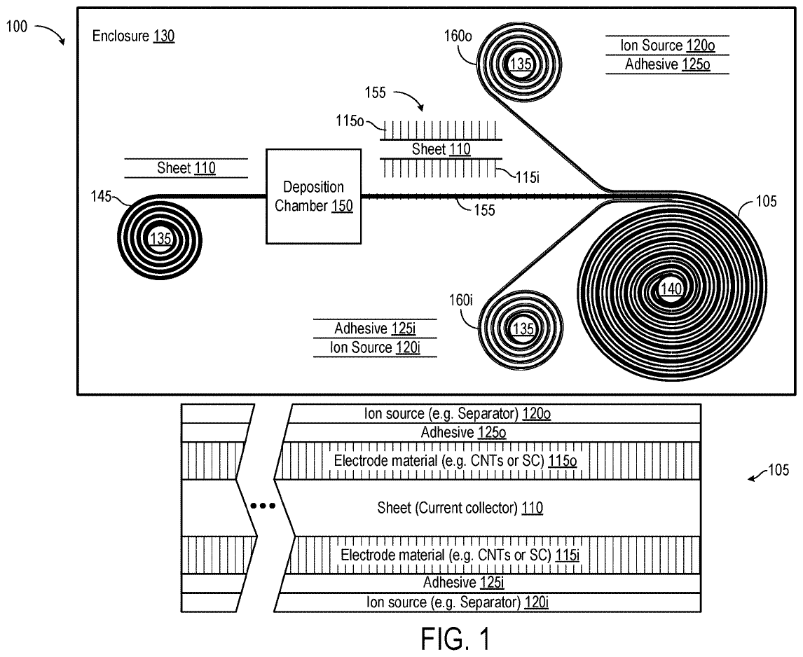

FIG. 1 depicts a system 100 for producing a laminate roll 105 of electrode material for electrochemical cells. A cross-section of laminate roll 105 is shown at the bottom. Referring to the cross section, laminate roll 105 includes a conductive sheet 110 having an inner side (bottom) and an outer side (top). The adjectives “inner” and “outer” distinguish similar paired elements in laminate roll 105, inner referring to the element closer to the center of the roll.

Sheet 110 will serve as current collector for a double-sided anode or cathode in a cell or cells. Accordingly, sheet 110 supports inner and outer electrode materials 115i and 1150. Anode electrode materials include graphite, carbon, metal oxides, metal hydroxides, and carbon nanomaterials. The material of sheet 110 is selected for use with the electrode materials and can be e.g. of copper, aluminum, carbon, or a combination of these and other materials. In one anode embodiment, the electrode materials are vertically aligned carbon nanotubes (CNTs) grown from a copper instance of sheet 110. In a cathode embodiment, the electrode materials are sulfurized carbon overlying an aluminum instance of sheet 110. Lithium is the active material in each of these examples, “active” meaning that lithium ions are the charge carriers reversibly stored and released by the electrode materials.

Inner electrode material 115i is attached to an inner ion-source layer 120i via an inner adhesive layer 125i; likewise, outer electrode material 1150 is attached to an outer ion-source layer 1200 via an outer adhesive layer 1250. The ion-source material of layers 120i and 1200 can be of (1) an ionically permeable material, such as a porous polymer for use as a separator, (2) an ionically conductive material, such as a solid electrolyte, (3) an active material, or reductant, that provides the mobile ions, or (4) a combination of an active material and ionically permeable or conductive materials.

Adhesive layers 125i and 1250 are e.g. polyimide film adhesives that serve both to stabilize electrode materials 115i and 1150 and bond them to respective layers 120i and 1200. In one anode configuration, each of adhesive layers 125i and 1250 binds a respective carpet of carbon nanotubes to a respective separator. Inner and outer ion-source layers 125i and 1250 and their respective adhesive layers 125i and 1250 passivate and protect their respective underlying electrode materials 115i and 1150 as the laminate is rolled, stored, and subsequently handled in cell assembly. Inner and outer ion-source layers 120i and 1200 are adjacent when coiled into laminate roll 105.

Laminate roll 105 is assembled within an enclosure 130 that allows formation within an environment that can be controlled to facilitate anode or cathode formation. The assembly is produced via a so-called “roll-to-roll” machine in which multiple films, or webs, from respective source spools 135 are laminated and spooled onto a common output spool 140. Both sides of sheet 110 are coated simultaneously in this example but can also be coated successively.

From left to right, a spool 145 of conductive sheet 110 is fed through a deposition chamber 150. Suitable processes for forming an anode having carbon-nanotube electrode material on a copper current collector and a cathode having sulfurized carbon on an aluminum current collector are detailed in US Publication 2022/0209216 to Salvatierra et al. entitled “Sulfurized-carbon cathode with conductive carbon framework,” which is incorporated herein by reference. Any ambiguity in claim construction should favor meanings derived from this disclosure over that publication.

Chamber 150 produces a web 155 with conductive sheet 110 sandwiched between inner and outer electrode-material layers 115i and 1150. Spools 1600 and 160i, each a laminate of an ion-source material and an adhesive, are laminated with and affixed to web 155. The combined laminate is wound around output spool 140. The resulting laminate roll 105 is then removed from enclosure 130 and stored for later use or combined with an alternative half-cell for cell formation. Examples of full cells are discussed in the above-referenced publication to Salvatierra et al.

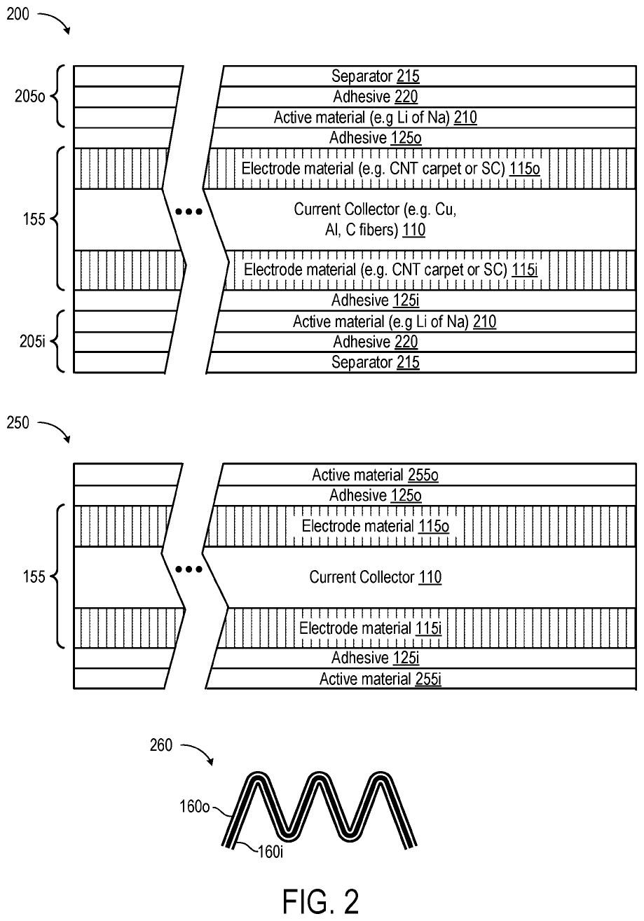

FIG. 2 depicts an anode laminate 200 in accordance with another embodiment. Laminate 200 is like laminate 105 of FIG. 1, with like-identified elements being the same or similar. In laminate 200, however, each ion-source layer 205i and 2050 is a composite of an active-material layer 210 joined to a separator 215 via a second adhesive layer 220. Active-material layer 210 can be of any suitable reductant and can be applied as e.g. a continuous, porous, or perforated web. The adhesive depicted on either side of each layer 210 can be one material layer that extends through a porous or perforated active material. For example, a single adhesive layer can bond a separator 215 to a carbon-nanotube anode layer or sulfurized-carbon cathode layer via a perforated lithium film that will provide the active charge carriers after cell assembly. Ion-source layers 2050 and 205i can be assembled before or with web 155 to produce a laminate roll.

FIG. 2 also depicts a laminate 250 in which the ion-source layers 255i and 2550 are anode or cathode active material. Separators, if required, can be applied later, e.g. during cell assembly. A final laminate 260 of FIG. 2 illustrates an embodiment in which the laminates of spools 1600 and 160i are combined with web 155 and folded or cut to shape and stacked within chamber 130 rather than spooled.

While systems and methods for forming electrode laminates have been described in connection with specific embodiments, variations of these embodiments are also envisioned. For example, while rolls are generally cylindrical, laminate rolls can be of any shape created when a flat material is wound around itself. Moreover, laminate rolls can be used to form capacitors (e.g. supercapacitors or hybrid supercapacitors). These examples are in no way exhaustive, as many alternatives within the scope of the claims will be obvious to those of ordinary skill in the art. Therefore, the spirit and scope of the appended claims should not be limited to the foregoing description.

What is claimed is:

1. A laminate roll comprising:
a conductive sheet having an inner side and an outer side;
an inner electrode material on the inner side of the conductive sheet;
an inner adhesive layer on the inner electrode material;
an inner ion-source layer opposite the inner side of the conductive sheet via the inner adhesive layer;
an outer electrode material on the outer side of the conductive sheet;
an outer adhesive layer on the outer electrode material; and
an outer ion-source layer opposite the outer side of the conductive sheet via the outer adhesive layer;
the inner and outer ion-source layers adjacent in the laminate roll.

2. The laminate roll of claim 1, wherein the inner ion-source layer is bonded to the inner electrode material via the inner adhesive layer.

3. The laminate roll of claim 1, further comprising an inner active material between the inner adhesive layer and the inner ion-source layer.

4. The laminate roll of claim 3, wherein the inner active material comprises a foil.

5. The laminate roll of claim 3, further comprising a second inner adhesive layer bonding the inner electrode material to the inner ion-source layer.

6. The laminate roll of claim 3, wherein the inner adhesive layer extends through the inner active material.

7. The laminate roll of claim 1, wherein the inner and outer ion-source layers comprise an ionically conductive material.

8. The laminate roll of claim 1, wherein the inner and outer ion-source layers comprise porous polymers.

9. The laminate roll of claim 1, wherein the inner and outer ion-source layers comprise an anode metal.

10. The laminate roll of claim 9, wherein the anode metal comprises lithium metal.

11. The laminate roll of claim 1, wherein the conductive sheet is predominantly of at least one of copper, aluminum, and carbon.

12. The laminate roll of claim 1, wherein at least one of the inner electrode material and the outer electrode material comprises carbon nanomaterial.

13. The laminate roll of claim 12, wherein the carbon nanomaterial comprises carbon nanotubes.

14. The laminate roll of claim 1, wherein at least one of the inner ion-source layer and the outer ion-source layer comprises a separator for use in at least one of a capacitor and an electrochemical cell.

15. The laminate roll of claim 1, wherein at least one of the inner ion-source layer and the outer ion-source layer comprises an ionically permeable material.

16. The laminate roll of claim 1, wherein at least one of the inner adhesive layer and the outer adhesive layer comprises polyimide.

17. The laminate roll of claim 1, wherein the laminate roll is of a cylindrical cross section.

18. A method of assembling an electrode roll, the method comprising:
preparing a laminate by:
depositing an inner electrode material on an inner side of a conductive sheet and an outer electrode material on an outer side of the conducive sheet;
applying an inner adhesive layer on the inner electrode material and an outer adhesive layer on the outer electrode material;
applying an inner ion-source layer over the inner adhesive layer and an outer ion-source layer over the outer adhesive layer; and
rolling the laminate into the electrode roll such that the inner ion-source layer is adjacent the outer ion-source layer.

19. The method of claim 18, wherein the inner ion-source layer is in contact with and separate from the outer ion-source layer in the electrode roll.

20. The method of claim 18, further comprising:
enclosing a source roll of the inner electrode material in an enclosure; and
controlling environmental variables within the enclosure to create an enclosure environment;
wherein the inner adhesive layer and the inner ion-source layer are deposited in the enclosure environment, and wherein the rolling is performed within the enclosure environment.

21. The method of claim 20, wherein depositing the inner electrode material and the outer electrode material comprises chemical vapor deposition.

22. The method of claim 21, wherein the inner electrode material and the outer electrode material comprise carbon nanomaterials.

23. The method of claim 18, wherein the conductive sheet is predominantly of at least one of copper, aluminum, and carbon.

24. The method of claim 18, wherein the inner ion-source layer and the outer ion-source layer are ionically permeable.

25. The method of claim 18, further comprising applying an inner layer of an active electrode material between the inner ion-source layer and the inner adhesive layer and applying an outer layer of the active electrode material between the outer ion-source layer and the outer adhesive layer.
